(19) United States
(12) Patent Application Publication
(10) Pub. No.: US 2014/0060965 A1
(43) Pub. Date: Mar. 6, 2014

(54) ACOUSTIC PANEL

(71) Applicant: Jarmo Pölönen, Joensuu (FI)

(72) Inventor: Jarmo Pölönen, Joensuu (FI)

(73) Assignee: YESECO OY, Joensuu (FI)

(21) Appl. No.: 14/114,617

(22) PCT Filed: May 14, 2012
(86) PCT No.: PCT/FI2012/050461

§ 371 Date: Oct. 29, 2013

(30) Foreign Application Priority Data
May 19, 2011 (FI) 20115485

(51) Int. Cl. G10K 11/168; B32B 5/22; B32B 3/12

(52) U.S. Cl. CPC G10K 11/168; B32B 3/12; B32B 5/22
USPC 181/292

(57) ABSTRACT

Disclosed is an acoustic panel that includes a surface element including fibrous material. The acoustic panel also includes a back element that has a honeycomb structure and includes fibrous material, and an intermediate element that is arranged between the surface element and back element and has a porous structure.

### BACKGROUND

The invention relates to an acoustic panel that comprises a surface element comprising fibrous material.

In this specification, an acoustic panel or acoustic element refers to a panel or element fitted in a room to shorten the reverberation time, that is, the duration of the echo, in the room.

A problem with known acoustic panels is that their acoustic properties may be deficient.

### BRIEF DESCRIPTION

The object is to provide an acoustic panel with properties better than those of the known acoustic panels. This object is achieved by an acoustic panel which is characterized by what is disclosed in the independent claim. Preferred embodiments of the solution are disclosed in the dependent claims.

The invention is based on the fact that the acoustic panel also comprises a back element having a honeycomb structure and comprising fibrous material, and an intermediate element that is arranged between the surface element and back element and has a porous structure.

The acoustic panel provides the advantage that its absorption ratio is extremely high.

### BRIEF DESCRIPTION OF THE FIGURES

The solution will now be described by means of a few embodiments, with reference to the accompanying drawings, in which:

FIG. 1 is a schematic cross-sectional view of an embodiment of an acoustic panel,

FIG. 2 is a schematic exploded view of the acoustic panel of FIG. 1,

FIG. 3 is a schematic back view of the acoustic panel of FIG. 1,

FIG. 4 is a schematic exploded view of a second embodiment of an acoustic panel,

FIG. 5 is a schematic perspective and cross-sectional view of a third embodiment of an acoustic panel, and

FIG. 6 shows the absorption ratio of an embodiment of an acoustic panel.

In the figures, the embodiments are shown simplified for the sake of clarity. Like reference numerals refer to like parts in the figures.

### DETAILED DESCRIPTION

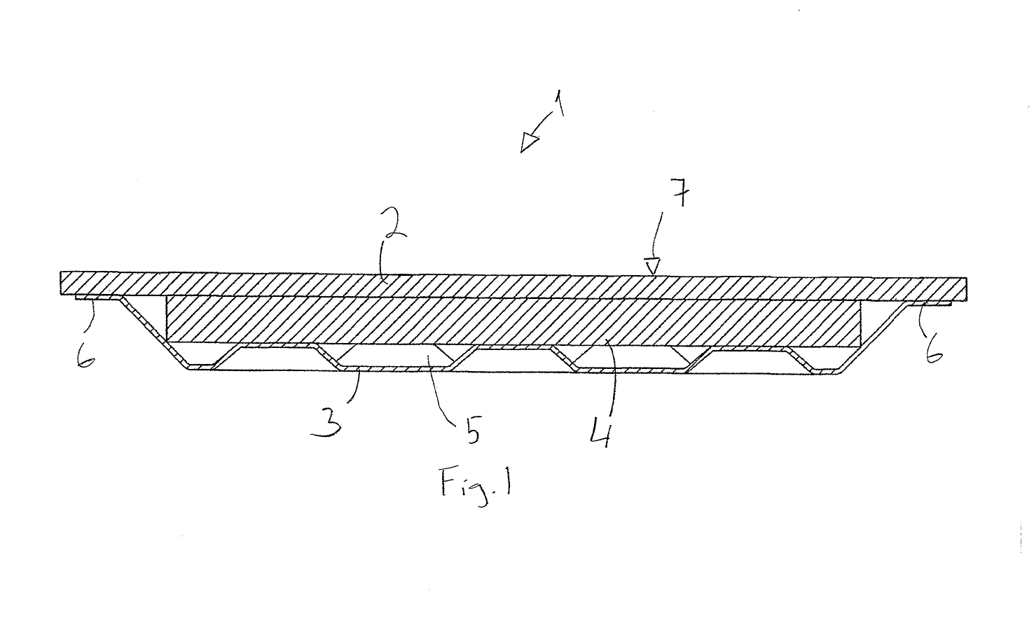

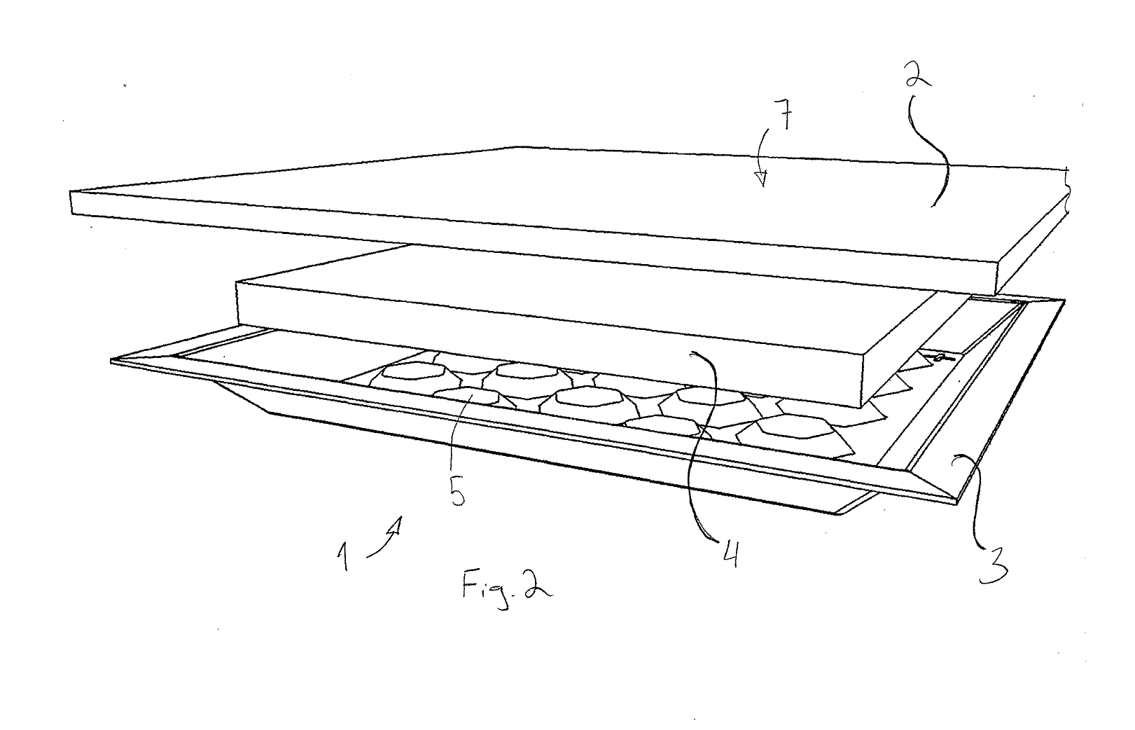

FIG. 1 is a schematic cross-sectional view and FIG. 2 is an exploded view of an embodiment of the acoustic panel of the invention.

The structure of the acoustic panel 1 is layered and comprises a surface element 2, back element 3 having a honeycomb structure, and an intermediate element 4 that is arranged between the surface element 2 and back element 3.

The surface element 2 can be fastened to the back element 3 on the edge parts 6 of the latter by gluing, riveting, velcro tape or in some other corresponding known manner. Said fastening can naturally also be done elsewhere than on the edge parts 6.

The surface element 2 shown in the figures is essentially even on its front surface 7. Alternatively, the front surface 7 comprises three-dimensional shapes that may be formed for instance by pressing or attaching sectional pieces of different shapes and thicknesses to the surface element 2.

The intermediate element 4 may be arranged in the space formed between the surface element 2 and back element 3. The intermediate element 4 may be one- or multi-layered. In the figures, there is one intermediate element 4 between the surface element 2 and back element 3. In other embodiments, there are two or more intermediate elements 4 between the surface element 2 and back element 3.

The surface element 2 and back element 3 are mainly made of a material mix that comprises fibrous material and a thermoplastic binder. The fibrous material may be of a synthetic fibre, natural fibre, or comprise both of them.

In some embodiments, the fibrous material preferably contains only natural fibres. In this specification, natural fibre refers to fibre, the fibre material of which originates from plants or animals. Natural fibre may be flax, hemp, jute, coconut, manila or sisal fibre, wool, etc. Natural fibre provides the advantage that it is ecological and easy to dispose of.

In terms of the terminology of this specification, all other fibres than natural fibres are synthetic fibres.

The fibrous material is, if necessary, bound into an element by adding a binder that may be a thermoplastic polymer or thermoset polymer. However, it should be noted that adding a binder is not necessary when the fibrous material contains binding components, such as lignin. The binder may be polyethylene PE, polypropylene PP, polyethylene terephthalate PET, polylactide, polyglycolide, etc.

The binder is preferably a natural polymer or synthetic material disposable by burning.

The surface element 2 may be made either of the same raw material as the back element 3 or of a different raw material.

Images may be printed or artwork created by serigraphy or painting on a suitably primed surface element 2. The surface element 2 may also be coated with a fabric and/or it may be painted or otherwise processed with colouring agents or the like.

The back element 3 has a honeycomb structure. The back element 3 shown in the figures comprises cells 5 of a hexagonal basic shape and equal in size arranged in a regular order. The shape, depth and size of the cell 5 may naturally also be other than shown in the figures. It is possible to arrange cells 5 of different shape and/or size in the same back element 3. The distance between adjacent cells 5 may differ at different parts of the back element 3.

The intermediate element 4 is of porous structure, preferably cotton-like. It may be made of the same raw materials as the surface element 2 and/or back element 3. The intermediate element 4 may be of PET-bound hemp, recycled textile wadding or the like.

By altering the density of the material and the thickness of the element 2, 3, 4, it is possible to affect sound attenuation and acoustic reflection. The material is also very tough and impact resistant.

The elements 2, 3, 4 may naturally also comprise parts made of other materials than the above-mentioned fibrous material. By using additives, the manufacturing material of the elements 2, 3, 4 is made fire-resistant and slow-burning.

The acoustic panel 1 is arranged in a room in such a manner that the surface element 2 settles in the main incoming direction of sound.

The acoustic panel 1 may be used as an acoustic board or a panel fastened to the wall or ceiling. The acoustic panel 1 can also be formed into dividing screens, in which case one or, in most cases, several acoustic panels 1 are fastened to the framework of the dividing screen.

The surface element 2, back element 3 and intermediate element 4 can each be made by hot-pressing fibrous raw material and a binder possibly mixed therein in a mould. The temperature is then increased so high that the binder—either an added binder or a binder inherent to the fibres—softens or melts. The fibres then attach to each other by means of the binder. As the product cools, the fibres remain attached to each other. Three-dimensional shapes may be designed on the surface element 2 in the mould. The acoustic panel 1 may be made by laminating, for example, with or without glue layers between the layers.

A three-dimensional surface may also be made by adding material layers on the surface element 2 to create bossage on the surface. The surface element 2 and the entire acoustic panel 1 may in basic form be not only planar, as shown in the figure, but also curved, concave, convex, etc.

The intermediate element 4 located between the surface element 2 and back element 3 improves sound attenuation. The thickness and density of the surface element 2 also affect sound attenuation. In addition, the height and shapes of the cells 5 of the back element 3 affect sound attenuation. The surfaces of the cells 5, especially bevelled surfaces, refract and disperse sound waves hitting them. In result, the energy of the sound waves disperses and attenuates as the sound waves return to the intermediate element 4 and/or surface element 2. In an embodiment, the density of the back element 3 is higher than that of the intermediate element 4 and surface element 2, whereby the sound reflects from the back element 3 to the less dense and well attenuating intermediate and surface elements 4, 2.

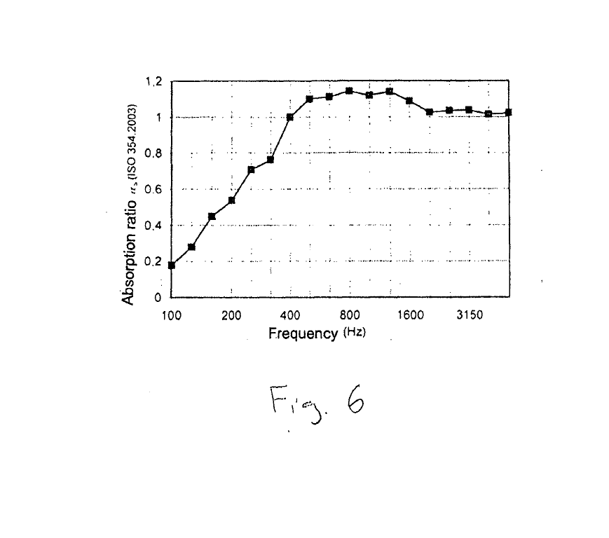

Structures that attenuate or reflect sound can be made of the material. As density increases, the sound-reflecting property typically increases and the sound-attenuating property decreases. The opposite takes place as density decreases. FIG. 6 shows the performance of an acoustic panel.

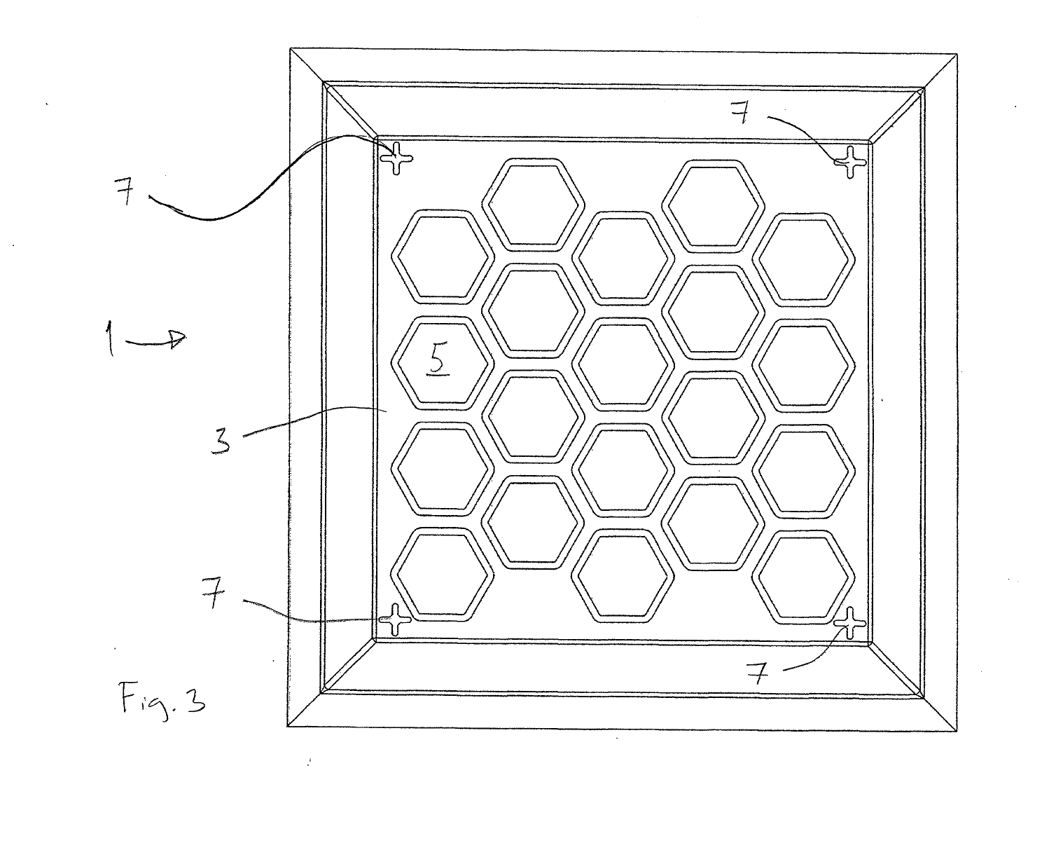

FIG. 3 is a schematic back view of the acoustic panel of FIG. 1, that is, from the side of the back element 3.

Fastening members 7 are arranged at the corners of the back element 3, with which the acoustic panel 1 can be fastened in place on a wall or the like. In this embodiment, the fastening member 7 is a cross-shaped opening, but it is clear that it can be of some other shape. The fastening member 7 is not necessarily an opening: it may also be a bracket, such as a hook, loop, rail, groove or the like. The acoustic panel 1 can also be fastened in place by gluing, velcro tape, or in some other manner known per se.

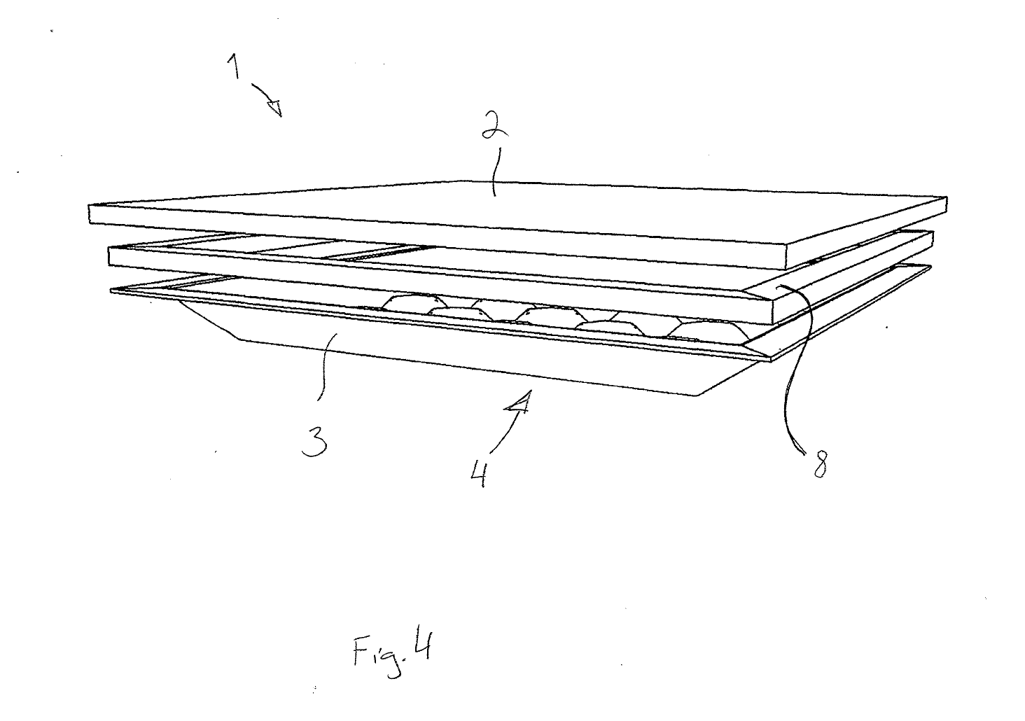

FIG. 4 is a schematic exploded view of a second embodiment of an acoustic panel.

Here, a raising frame 8 is arranged between the surface element 2 and back element 3. It may be made of the same raw materials as the surface element 2 and/or back element 3 and fastened in place by gluing, velcro tape, or in some other manner known per se.

The raising frame 8 improves sound attenuation. This is based on the additional thickness or space which it creates and which can be filled with an intermediate element 4. Additional thickness improves the attenuation of low sounds, in particular.

One or more raising frames 8 may be fastened between the surface element 2 and back element 3. It may also be integrated into the surface element 2 or back element 3.

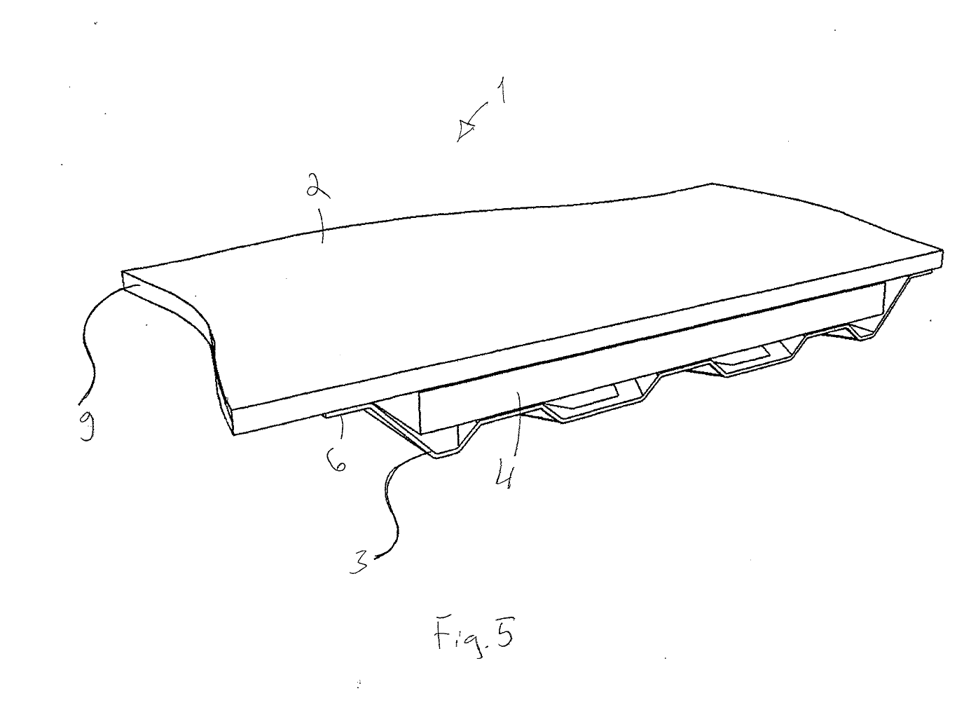

FIG. 5 is a schematic perspective and cross-sectional view of a third embodiment of an acoustic panel.

The edge 9 of the surface element can be cut into various two-dimensional shapes. As seen in the figure, the edge part 6 of the back element may have a different shape than the edge 9 of the surface element.

FIG. 6 shows the absorption ratio of an embodiment of an acoustic panel. An acoustic panel, 1284×784 mm in size and 2.90 kg/m² in density, was measured. The thickness of the surface element 2 was 15 mm and the material was PET-bound hemp fibre. The thickness of the intermediate element 4 was 42 mm and the material recycled textile wadding.

In light of the results, the absorption ratio of the acoustic panel is excellent in frequency ranges over 400 Hz, in particular.

It will be apparent to a person skilled in the art that as technology advances, the basic idea of the solution may be implemented in many different ways. The embodiments are thus not restricted to the examples described above but may vary within the scope of the claims.

### REFERENCE NUMERALS

1 Acoustic panel

2 Surface element

3 Back element

4 Intermediate element

5 Cell

6 Edge part of back element

7 Fastening member

8 Raising frame

9 Edge of surface element

1. An acoustic panel that comprises a surface element comprising fibrous material, wherein the acoustic panel further comprises
a back element that is of honeycomb structure and comprises fibrous material, and
an intermediate element that is arranged between the surface element and back element and has a porous structure.

2. An acoustic panel as claimed in claim 1, wherein the fibrous material contains natural fibres.

3. An acoustic panel as claimed in claim claim 1, wherein the surface element and back element are made of the same material.

4. An acoustic panel as claimed in claim 2, wherein the surface element and back element are made of the same material.
